(19) United States
(12) Patent Application Publication
(10) Pub. No.: US 2011/0221655 A1
(43) Pub. Date: Sep. 15, 2011

(54) TWO-IMAGE DISPLAY APPARATUS

(75) Inventor: Toru Fukui, Tottori (JP)

(73) Assignee: SONY CORPORATION, Tokyo (JP)

(21) Appl. No.: 13/040,485

(22) Filed: Mar. 4, 2011

(30) Foreign Application Priority Data
Mar. 10, 2010 (JP) P2010-052784

(51) Int. Cl. G09G 5/00

(52) U.S. Cl. 345/4

(57) ABSTRACT

A two-image display apparatus includes: a display panel in which each sub-pixel for displaying a first image and each sub-pixel for displaying a second image are placed alternately at positions adjacent to each other; and a light shielding barrier having apertures for allowing the first and second images displayed in a first visual recognition direction and a second visual recognition direction respectively to be distinguished from each other, wherein the center of each of the apertures is shifted from the center between two-image areas allocated to two the adjacent sub-pixels respectively toward the side of the second visual recognition direction, and there is also provided a correction light shielding section configured to narrow an image area allocated on the side of the first visual recognition direction to serve as the image area provided for one of the adjacent sub-pixels.

### CROSS REFERENCES TO RELATED APPLICATIONS

The present application claims priority to Japanese Priority Patent Application JP 2010-052784 filed in the Japan Patent Office on Mar. 10, 2010, the entire content of which is hereby incorporated by reference.

### BACKGROUND

In general, the present invention relates to a two-image display panel used typically in the display unit of a navigation apparatus. To put it in detail, the present invention relates to a two-image display panel having a first image visual recognition range and a second image visual recognition range which are arranged asymmetrically by shifting the positions of the apertures of a light shielding barrier.

In comparison with a CRT (Cathode Ray Tube) display panel, an FPD (Flat Panel Display) panel such as a liquid-crystal display panel or an organic EL panel is characterized that the FPD panel has a small weight, a small thickness and a low power consumption. Thus, the FPD panel is used as a display panel in a number of electronic apparatus. Accompanying recent diversification of electronic apparatus, at the same time, there has been developed a two-image display panel for displaying a plurality of different images in a state of being distinguishable from each other when the images are observed from locations separated away from the two-image display panel in visual recognition directions different from each other. The two-image display panel displays different images by placing sub-pixels each serving as a smallest unit of any specific one of the images at positions adjacent to sub-pixels each serving as a smallest unit of any other one of the images, but separating the sub-pixels of the specific image and the sub-pixels of the other image from each other into a state which allows the specific image and the other image to be distinguished from each other when the specific image and the other image are observed from respectively locations separated away from the two-image display panel in visual recognition directions different from each other. As typical examples of a technology for separating displayed images into images displayed on two screens, there are known, among other technologies, a technology making use of a lenticular lens, a technology based on stripe-shaped protrusion patterns provided on both sides of the position facing a signal line, a technology based on a light shielding pattern of a liquid-crystal shutter and a technology based on a light shielding pattern of a light shielding member.

The two-image display panel is used in applications, being applied to apparatus such as a three dimensional image display apparatus taking directions to the left and right eyes of a user as different visual recognition directions, a display apparatus used as a learning tool including a display panel sandwiched by a group of students and a teacher who face each other and a display apparatus taking the two directions to the seat of a driver and the seat of an assistant driver as different visual recognition directions. In particular, a number of display apparatus taking the two directions to the seat of a driver and the seat of an assistant driver as different visual recognition directions are put on the market. This is because it is prohibited to display an image such as a received TV image or a DVD-reproduced image at a location, which is separated away from the seat provided for the driver in the driving direction, in order to assure the safety of driving while the driver is driving the car.

It is feared, however, that while the driver is driving the car, the driver may peep an image displayed on the side of the seat provided for the assistant driver in an attempt to look at the image which can be a received TV image, a DVD-reproduced image or the like, putting the safety of the driving at risk. In order to solve this problem of assuring the safety of driving, an effort to separate the visual-field range of an image displayed on the side of the seat provided for the assistant driver far away from the driver has been thought of. As a simple method for separating the visual-field range of an image displayed on the side of the seat provided for the assistant driver far away from the driver, there has been disclosed a method for shifting a light shielding pattern in Japanese Patent Laid-open No. 2006-184860. As described in Japanese Patent Laid-open No. 2005-091561 (hereinafter referred to as Patent Document 2), this disclosed method is adopted in a two-image display apparatus functioning as a learning tool including a display panel sandwiched by a group of students and a teacher who face each other and can also be applied to a case in which an image being looked at by a teacher is deliberately made difficult to look at by a group of students.

### SUMMARY

In a liquid-crystal display panel, on the other hand, even if voltages for gradations determined in advance are applied, when gradations of adjacent sub-pixels are different from each other, electrical crosstalk may be generated, resulting in different levels of luminance in some cases. This electrical crosstalk is conceivably caused by the fact that a spike, which is generated when a voltage appearing on a scan line is changed from one level to another, changes the effective value of the voltage applied to a pixel electrode. Particularly, in an electronic apparatus for displaying a plurality of different images in a state of being distinguishable from each other when the images are observed from locations separated away from the electronic apparatus in visual recognition directions different from each other as described above, images different from each other are supplied to adjacent sub-pixels so that much electrical crosstalk is generated.

In order to solve the electrical-crosstalk problem described above, in a liquid-crystal display apparatus employing a liquid-crystal display panel, a voltage completing an electrical-crosstalk correction process is applied to the liquid-crystal display panel as a corrected voltage. A method for carrying out the electrical-crosstalk correction process is described as follows. First of all, correction data representing all combinations of gradations of correction-subject sub-pixels and gradations of sub-pixels each adjacent to one of the correction-subject sub-pixels is found experimentally in advance in order to create an electrical correction table which is also referred to hereafter as an electrical LUT (Lookup Table). A correction-subject sub-pixel is a sub-pixel which is serving as the subject of a crosstalk correction process, that is, a sub-pixel which is being subjected to a crosstalk correction process. Then, the electrical LUT is stored in a memory (such as an EEPROM) of the liquid-crystal display apparatus. The liquid-crystal display apparatus reads out the correction data representing combinations of gradations of correction-subject sub-pixels and gradations of sub-pixels each adjacent to one of the correction-subject sub-pixels from the electrical LUT. Then, the liquid-crystal display apparatus adds the correction data to the gradations of the correction-subject sub-pixels in order to produce sums which are then output to the liquid-crystal display panel as corrected gradations of the correction-subject sub-pixels.

In addition, much like the two-image display apparatus or the like, in an electronic apparatus having a light shielding pattern, optical crosstalk attributed to a slit of a light shielding pattern is also generated. The cause of this optical crosstalk is an optical leak occurring due to the fact that light coming from a sub-pixel pertaining to a pixel adjacent to an observed sub-pixel to serve as an adjacent sub-pixel having the same color as the observed sub-pixel is diffracted at the slit of the light shielding pattern. Thus, an optical-crosstalk correction process needs to be carried out on the observed sub-pixel which is referred to hereafter as a correction-subject sub-pixel. A method for carrying out the optical-crosstalk correction process is described as follows. First of all, correction data representing all combinations of gradations of correction-subject sub-pixels and gradations of sub-pixels each pertaining to a pixel adjacent to a specific one of the correction-subject sub-pixels to serve as an adjacent sub-pixel having the same color as the specific correction-subject sub-pixel is found experimentally in advance in order to create an optical correction table which is referred to hereafter as an optical LUT (Lookup Table). Then, the optical LUT is stored in a memory (such as an EEPROM) of the liquid-crystal display apparatus. The liquid-crystal display apparatus reads out the correction data representing combinations of gradations of correction-subject sub-pixels and gradations of sub-pixels each pertaining to a pixel adjacent to a specific one of the correction-subject sub-pixels to serve as an adjacent sub-pixel having the same color as the specific correction-subject sub-pixel from the optical LUT. Then, the liquid-crystal display apparatus adds the correction data to the gradations of the correction-subject sub-pixels in order to produce sums which are then output to the liquid-crystal display panel as corrected gradations of the correction-subject sub-pixels.

As described above, an optical leak occurs due to, among other causes, the fact that light is diffracted at a light shielding pattern. If the light shielding pattern is shifted in order to deliberately make an image displayed on the side of the seat provided for the assistant driver difficult to visually recognize from a location on the side of the seat provided for the driver, however, there is raised a problem that the magnitude of the optical leak coming from one of sub-pixels each adjacent to the observed sub-pixel is increased as will be described below. That is to say, as shown in a diagram serving as FIG. 12A, if the light shielding pattern is not shifted, the magnitudes of the optical leaks coming from left and right sub-pixels each adjacent to the observed sub-pixel are equal to each other. In other words, in the upper diagram of FIG. 12A, adjacent sub-pixels G and R located on respectively the left and right-hand sides of a sub-pixel B provided for the side of the seat provided for the driver are sub-pixels provided for the side of the seat provided for the assistant driver. In this case, however, the sub-pixel B is unavoidably affected to a certain degree by optical leaks coming from the adjacent sub-pixels G and R located on respectively the left and right-hand sides of the sub-pixel B. Conversely, in the lower diagram of FIG. 12A, adjacent sub-pixels B and G located on respectively the left and right-hand sides of a sub-pixel R provided for the side of the seat provided for the assistant driver are sub-pixels provided for the side of the seat provided for the driver. In this case, however, the sub-pixel R is unavoidably affected to a certain degree by optical leaks coming from the adjacent sub-pixels B and G located on respectively the left and right-hand sides of the sub-pixel R. At that time, the effects of optical leaks coming from adjacent sub-pixels are basically equal to each other without regard to whether the adjacent sub-pixels are sub-pixels for the side of the seat provided for the assistant driver or the side of the seat provided for the driver.

If the aperture having a shape resembling a slit is shifted to the side of the seat provided for the assistant driver as shown in a diagram serving as FIG. 12B, on the other hand, the effect of an optical leak coming from an adjacent sub-pixel G serving as a sub-pixel for the side of the seat provided for the assistant driver on a sub-pixel B provided for the side of the seat provided for the driver increases as shown in the upper diagram of FIG. 12B. As shown in the upper diagram of FIG. 12B, the adjacent sub-pixel G is a sub-pixel provided at a location adjacent to the sub-pixel B on the left-hand side of the sub-pixel B. On the other hand, the effect of an optical leak coming from an adjacent sub-pixel R serving as a sub-pixel for the side of the seat provided for the assistant driver on the sub-pixel B decreases as shown in the upper diagram of FIG. 12B. As shown in the upper diagram of FIG. 12B, the adjacent sub-pixel R is a sub-pixel provided at a location adjacent to the sub-pixel B on the right-hand side of the sub-pixel B.

In addition, the effect of an optical leak coming from an adjacent sub-pixel B serving as a sub-pixel for the side of the seat provided for the driver on a sub-pixel R provided for the side of the seat provided for the assistant driver increases as shown in the lower diagram of FIG. 12B. As shown in the lower diagram of FIG. 12B, the adjacent sub-pixel B is a sub-pixel provided at a location adjacent to the sub-pixel R on the left-hand side of the sub-pixel R. On the other hand, the effect of an optical leak coming from an adjacent sub-pixel G serving as a sub-pixel for the side of the seat provided for the driver on the sub-pixel R decreases as shown in the lower diagram of FIG. 12B. As shown in the lower diagram of FIG. 12B, the adjacent sub-pixel G is a sub-pixel provided at a location adjacent to the sub-pixel R on the right-hand side of the sub-pixel R.

That is to say, as shown in the upper diagram serving as FIG. 12A, with the light shielding pattern not shifted, the sub-pixel B provided for the side of the seat provided for the driver has approximately a blue color. With the light shielding pattern shifted to the side of the seat provided for the assistant driver, on the other hand, the sub-pixel B undesirably shows a color which is very much affected by the green color (G) as shown in the upper diagram serving as FIG. 12B.

As shown in the lower diagram serving as FIG. 12A, with the light shielding pattern not shifted, the sub-pixel R provided for the side of the seat provided for the assistant driver has approximately a red color. With the light shielding pattern shifted to the side of the seat provided for the assistant driver, on the other hand, the sub-pixel R undesirably shows a color which is very much affected by the blue color (B) as shown in the lower diagram serving as FIG. 12B.

If the magnitudes of optical leaks coming from adjacent sub-pixels on the left and right-hand sides are different from each other as described above, as explained in Japanese Patent Laid-open No. 2009-080237, in a two-image display apparatus carrying out an optical-leak correction process by making use of correction tables of optical-leak magnitudes obtained experimentally, it is necessary to experimentally obtain two correction tables instead of only one correction table. In addition, the storage capacity of a memory used for storing the two correction tables is large, undesirably giving rise to a high cost.

It is desirable to address the problems described above to provide a two-image display apparatus allowing an optical-leak correction process to be carried out with ease by preventing the magnitudes of optical leaks coming from two adjacent sub-pixels from increasing and by reducing errors between the magnitudes of the optical leaks coming from the adjacent sub-pixels laid out on a two-image display panel employed in the two-image display apparatus to serve as a panel having a first image visual recognition range and a second image visual recognition range which are arranged asymmetrically by shifting the positions of the apertures of a light shielding barrier.

In order to achieve the desire described above, there is provided a two-image display apparatus employing:

a display panel in which each sub-pixel for displaying a first image and each sub-pixel for displaying a second image are placed alternately at positions adjacent to each other; and

a light shielding barrier having apertures for allowing the first and second images displayed in a first visual recognition direction and a second visual recognition direction respectively to be distinguished from each other.

In the two-image display apparatus, the center of each of the apertures is shifted from the center between two-image areas allocated to two aforementioned adjacent sub-pixels respectively toward the side of the second visual recognition direction. In addition, the two-image display apparatus is also provided with a correction light shielding section configured to narrow an image area allocated on the side of the first visual recognition direction to serve as the image area provided for one of the adjacent sub-pixels.

If the aperture of the light shielding barrier is shifted to the side of the second visual recognition direction, an optical leak generated on the side of the first visual recognition direction of the sub-pixel increases but an optical leak generated on the side of the second visual recognition direction of the sub-pixel decreases. In order to solve this problem, in the two-image display apparatus according to the present embodiment, the image area of the sub-pixel on the side of the first visual recognition direction is narrowed by making use of the correction light shielding section. Thus, all the optical leaks can be decreased and, at the same time, it is possible to reduce an error between the optical leak generated in the first visual recognition direction and the optical leak generated in the second visual recognition direction. It is to be noted that, in the two-image display apparatus according to the present embodiment, the correction light shielding section may be provided with a member having a light shielding property. Typical examples of the member having a light shielding property are a switching device and a spacer having a shape which resembles a pillar.

In addition, it is desirable to provide the two-image display apparatus according to the present embodiment with the correction light shielding section which has a shape gradually widened in a direction from the side of the second visual recognition direction to the side of the first visual recognition direction.

In accordance with the two-image display apparatus according to the present embodiment, the correction light shielding section has a shape which is gradually widened in a direction from the side of the second visual recognition direction to the side of the first visual recognition direction. Thus, even if the visual recognition direction is shifted a little bit from the design position, the luminance by no means changes substantially. As a result, it is possible to provide two-image display apparatus having few variations from each other.

In addition, it is desirable to provide the two-image display apparatus according to the present embodiment with the correction light shielding section which has a shape for partially shielding light propagating in the direction of a column, along which the sub-pixels are laid out, on the side of the first visual recognition direction.

Since every sub-pixel employed in the two-image display apparatus has components including a switching device, the shape of the aperture is asymmetrical in the horizontal direction from the beginning. In accordance with the two-image display apparatus according to the present embodiment, such a sub-pixel shape asymmetrical in the horizontal direction can be utilized to narrow the size of the image area on the side of the first visual recognition direction to a desired level without much reducing the openness of the aperture.

On top of that, it is desirable to provide the two-image display apparatus according to the present embodiment with the correction light shielding section which is created so that the magnitude of an optical leak generated on the side of the first visual recognition direction is equal to the magnitude of an optical leak generated on the side of the second visual recognition direction.

In the two-image display apparatus according to the present embodiment, the image area of the sub-pixel provided for the side of the first visual recognition direction is narrowed in order to make the magnitude of an optical leak generated on the side of the first visual recognition direction equal to the magnitude of an optical leak generated on the side of the second visual recognition direction. Thus, it is possible to make correction data of the sub-pixel serving as the subject of a correction process for the first visual recognition direction same as correction data of the sub-pixel serving as the subject of the correction process for the second visual recognition direction. As a result, in accordance with the two-image display apparatus according to the present embodiment, the time it takes to experimentally obtain a correction table can be prevented from being doubled. In addition, it is possible to prevent the storage capacity of a memory used for storing the correction table from increasing.

Additional features and advantages are described herein, and will be apparent from the following Detailed Description and the figures.

### BRIEF DESCRIPTION OF THE FIGURES

FIG. 1 is a diagram showing a typical layout of pixels employed in a liquid-crystal display panel;

FIG. 2 is a diagram showing the principle of a process to combine two-images in order to form a combined image;

FIG. 3A is a diagram showing the principle of a process to disassemble a combined image which is composed of two component images;

FIG. 3B is a diagram showing the top view of a light shielding pattern of a light shielding layer;

FIG. 4 is a top-view explanatory diagram to be referred to in description of a phenomenon in which crosstalk is generated;

FIG. 5 is a block diagram showing main components composing a two-image display apparatus;

FIG. 6 is a block diagram showing main components composing a crosstalk correction section employed in the two-image display apparatus shown in the block diagram which serves as FIG. 5;

FIG. 7A is a diagram showing white-reference LUTs;

FIG. 7B is a diagram showing an original-reference electrical LUT and a black-reference optical LUT;

FIG. 7C is a diagram showing black-reference LUTs;

FIG. 8A is a diagram showing a typical sub-pixel layout of FRC (Frame Rate Control) which handles four frames as one period;

FIG. 8B is a table showing correction values for the four frames;

FIG. 9A is a diagram showing the top view of a correction light shielding section employed in a first typical comparison configuration;

FIG. 9B is a diagram showing the top view of a correction light shielding section employed in a second typical comparison configuration;

FIG. 10A is a diagram showing the top view of a correction light shielding section employed in an embodiment;

FIG. 10B is an explanatory diagram showing states of optical leaks in a configuration including the correction light shielding section as shown in the diagram which serves as FIG. 10A;

FIG. 11A is a diagram showing the top view of a light shielding barrier employed in a first typical modified version;

FIG. 11B is a diagram showing the top view of a light shielding barrier employed in a second typical modified version;

FIG. 12A is an explanatory diagram showing states of optical leakages for a case in which a light shielding pattern is not shifted; and

FIG. 12B is an explanatory diagram showing states of optical leakages for a case in which a light shielding pattern is shifted to the side of a seat provided for an assistant driver.

### DETAILED DESCRIPTION

An embodiment of the present invention is explained below by referring to comparison configurations and diagrams. However, the embodiment explained below is by no means intended to limit the present invention to what is described below. Instead, the present invention can also be applied equally to a variety of modified versions of the embodiment as long as the modified versions do not deviate from technological concepts explained in the range of claims appended to the specification of the invention. It is to be noted that, in order to make the reader capable of easily recognizing layers and members in figures referred to in the description of the specification of the invention, the layers and the members are deliberately drawn in the figures with sizes of levels that can be recognized by the reader with ease. In addition, the scales used in drawing the layers and the members are also made different from layer to layer and from member to member so that, in consequence, the sizes of the layers and the members in the figures are not necessarily proportional to actual dimensions of the layers and the members.

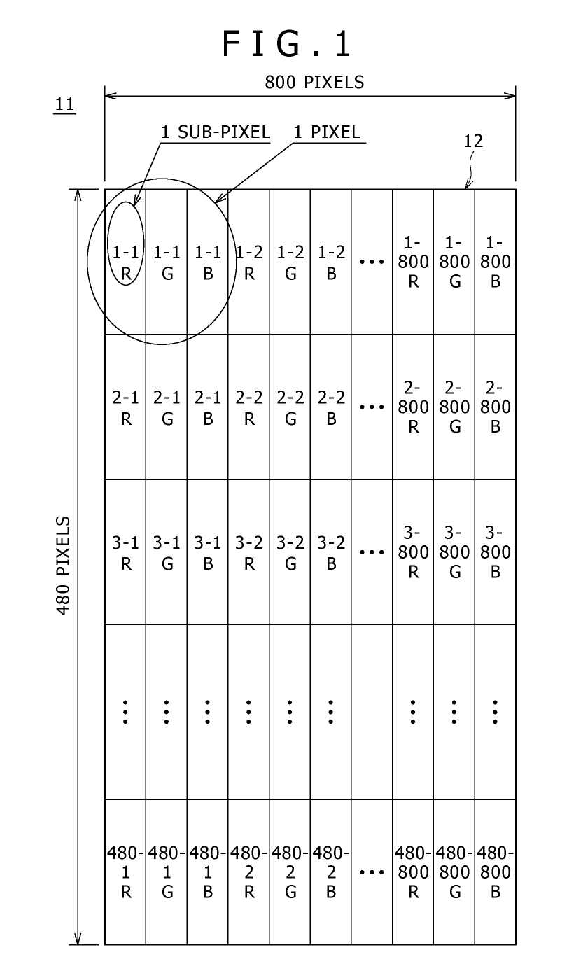

A two-image liquid-crystal display apparatus according to the embodiment and two-image display apparatus each having a typical comparison configuration are each a display apparatus for displaying a navigation image in the direction to the seat provided for the driver and a DVD-reproduced image in the direction to the seat provided for the assistant driver in a state of being distinguishable from each other. The two-image liquid-crystal display apparatus according to the embodiment is different from the two-image display apparatus each having a typical comparison configuration only in the shape of the opening of a light shielding barrier. For this reason, first of all, the principle of operations carried out by a general two-image display apparatus is explained by referring to diagrams which serve as FIGS. 1 to 8.

FIG. 1 is a diagram showing a typical layout of sub-pixels in a display area 12 of a liquid-crystal display panel 11 which is employed in a two-image display apparatus 10. The display area 12 is a color display area of the WVGA type. In the display area 12, there are typically 800 pixels connected to every scan line stretched in the horizontal direction (or the row direction) and typically 480 pixels connected to every signal line stretched in the vertical direction (or the column direction). The scan line and the signal line themselves are not shown in the diagram which serves as FIG. 1. Each of the pixels has three sub-pixels, i.e., R (red), G (green) and B (blue) sub-pixels which are laid out in the row direction. Each of the pixels has an approximately rectangular shape. The color of a pixel is determined by a mixture of the colors of the three sub-pixels, i.e., the R (red), G (green) and B (blue) sub-pixels which are included in the pixel.

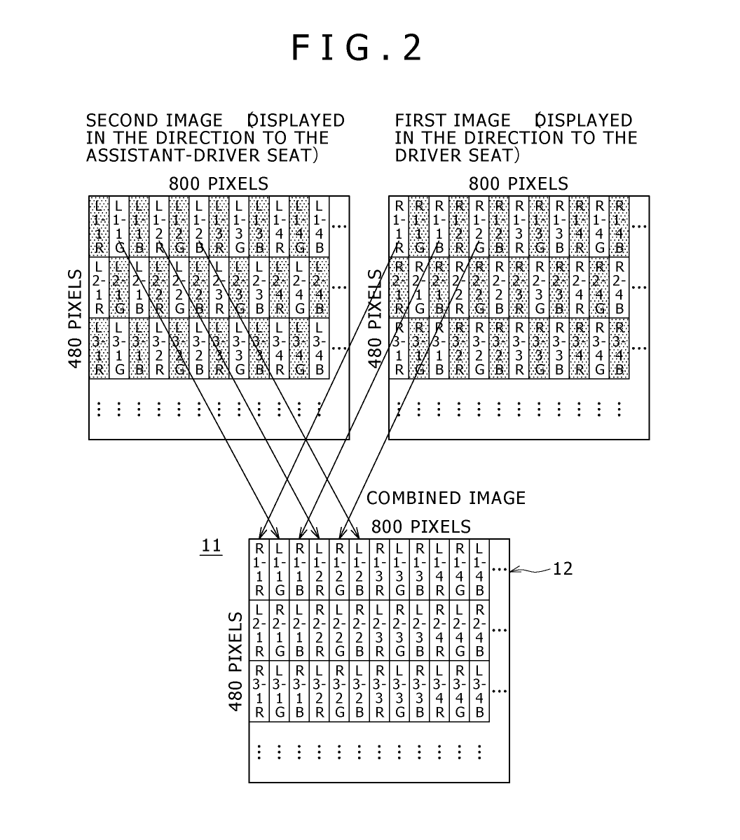

As shown in a diagram which serves as FIG. 2, an image displayed in the display area 12 is a combined image obtained by sorting out a first image and a second image in sub-pixel units to form a checker board design. The first image is an image displayed in the direction to the seat provided for the driver in a car with the steering wheel provided on the right-hand side. In the following description, the direction to the seat provided for the driver in a car with the steering wheel provided on the right-hand side is also referred to as the first visual recognition direction of the present embodiment. On the other hand, the second image is an image displayed in the direction to the seat provided for the assistant driver in a car with the steering wheel provided on the right-hand side. In the following description, the direction to the seat provided for the assistant driver in a car with the steering wheel provided on the right-hand side is also referred to as the second visual recognition direction of the present embodiment.

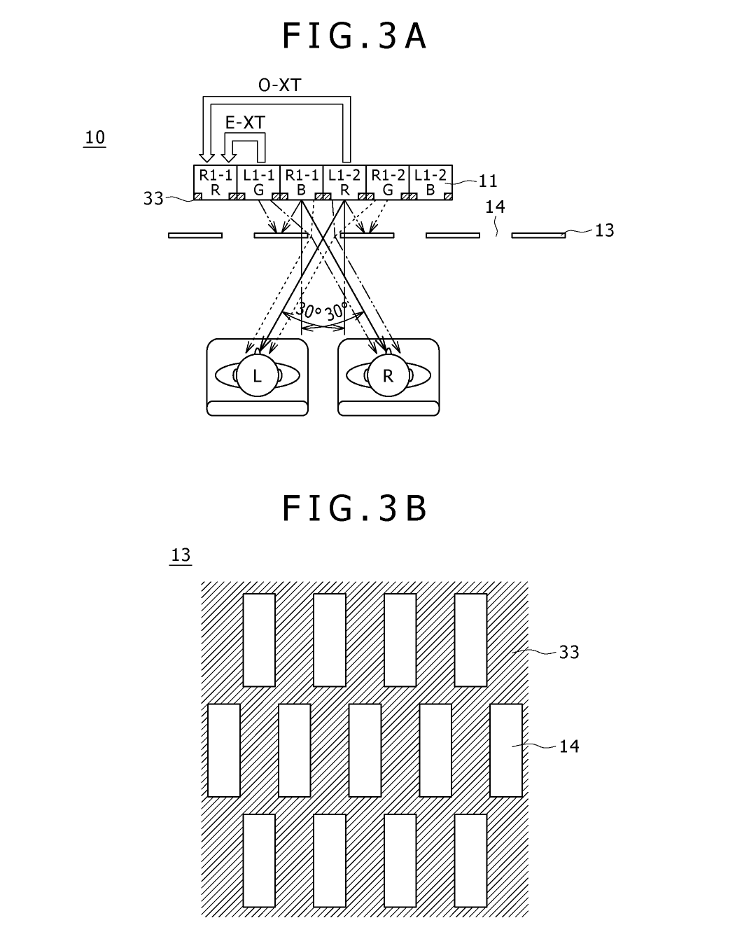

As shown in a diagram which serves as FIG. 3A, a light shielding barrier 13 on the right-hand side of the figure is created on the liquid-crystal display panel 11 of the display area 12. As shown in a diagram which serves as FIG. 3B, a light shielding pattern of slit-shaped apertures 14 forming the checker board design is created on the light shielding barrier 13. The sub-pixels for displaying the first image are located alternately with and adjacently to the sub-pixels for displaying the second image. Due to the slit-shaped apertures 14 on the light shielding barrier 13, in the R direction to the seat provided for the driver in a car with the steering wheel provided on the right-hand side, the second image cannot be visually recognized and, thus, only the first image can be visually recognized. In the L direction to the seat provided for the assistant driver in a car with the steering wheel provided on the right-hand side, on the other hand, the first image cannot be visually recognized and, thus, only the second image can be visually recognized. For example, in the R direction to the seat provided for the driver in a car with the steering wheel provided on the right-hand side, only a navigation image can be visually recognized whereas, in the L direction to the seat provided for the assistant driver in a car with the steering wheel provided on the right-hand side, only a DVD-reproduced image can be visually recognized. In such a configuration, the R direction to the seat provided for the driver in a car with the steering wheel provided on the right-hand side is a direction forming a predetermined angle of typically +30 degrees in conjunction with the direction perpendicular to the display surface of the liquid-crystal display panel 11. On the other hand, the L direction to the seat provided for the assistant driver in a car with the steering wheel provided on the right-hand side is a direction forming a predetermined angle of typically −30 degrees in conjunction with the direction perpendicular to the display surface of the liquid-crystal display panel 11. That is to say, the R direction and the L direction are symmetrical with respect to the direction perpendicular to the display surface of the liquid-crystal display panel 11.

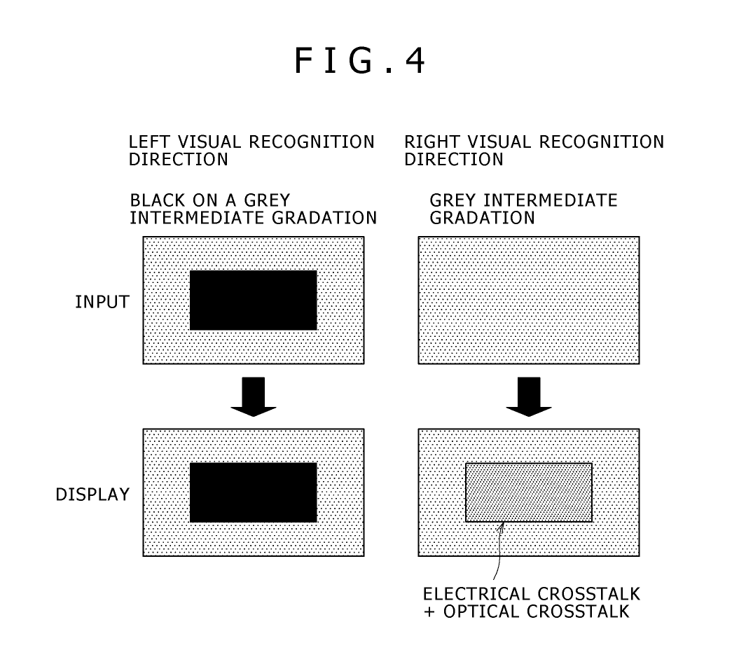

As shown in the diagram which serves as FIG. 2, in a combined image composed of component images different from each other and adjacent to each other, voltages of gradations different from each other are most likely applied to adjacent sub-pixels in comparison with a case in which only either of the component images is displayed. If voltages of gradations different from each other are applied to adjacent sub-pixels, electrical crosstalk (E-XT) is generated with ease. This electrical crosstalk is conceivably caused by the fact that a spike, which is generated when a voltage appearing on a scan line is changed from one level to another, alters the effective value of the voltage applied to a pixel electrode. For example, when the image displayed in the left (L) visual recognition direction has a black center on an intermediate-gradation grey background whereas the image displayed in the right (R) visual recognition direction is an intermediate-gradation grey solid image as shown in a top-view explanatory diagram serving as FIG. 4, the center of the image displayed in the right (R) visual recognition direction is displayed in a slightly dark intermediate-gradation grey color due to an effect such as the fact that the voltage undesirably varies because of electrical crosstalk.

The electrical crosstalk is by no means limited to the electrical crosstalk generated in the case of a combined image described above. That is to say, the electrical crosstalk is generally generated when gradations of adjacent sub-pixels are different from each other. Anyway, in a combined image in particular, sub-pixels of component images different from each other are placed at positions adjacent to each other so that the amount of generated electrical crosstalk is very large. Thus, the two-image display apparatus 10 needs to correct the generated electrical crosstalk. In addition, as shown in the diagram serving as FIG. 3A, light is diffracted at the slit-shaped aperture 14 of the light shielding barrier 13 so that, in a phenomenon referred to as optical crosstalk (O-XT), leaking light propagates to an observed sub-pixel from a same-color sub-pixel included in a pixel adjacent to the observed sub-pixel to serve as a same-color sub-pixel having the same color as the observed sub-pixel. This optical crosstalk also needs to be corrected.

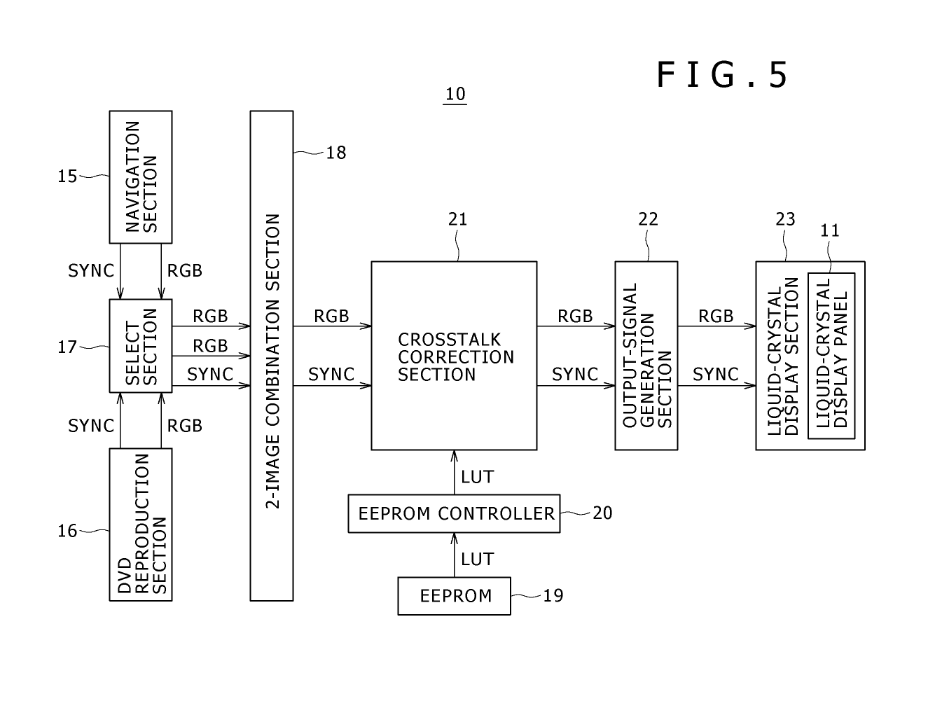

FIG. 5 is a block diagram showing main components composing a two-image display apparatus 10 which has a crosstalk correction section 21 for correcting electrical crosstalk as well as optical crosstalk. As shown in the figure, the two-image display apparatus 10 employs a navigation section 15, a DVD generation section 16, a select section 17, a two-image combination section 18, an EEPROM 19, an EEPROM controller 20, the crosstalk correction section 21 cited above, an output-signal generation section 22 and a liquid-crystal display section 23.

The navigation section 15 outputs a pre-combination navigation image not subjected yet to an image combination process to the select section 17 whereas the DVD generation section 16 outputs a pre-combination DVD-reproduced image not subjected yet to the image combination process to the select section 17. The select section 17 selects the navigation image output by the navigation section 15 or the DVD-reproduced image output by the DVD generation section 16 and takes the selected image as a first image shown in the diagram serving as FIG. 2 as a first image which is not subjected yet to the image combination process. In addition, the select section 17 also selects the navigation image output by the navigation section 15 or the DVD-reproduced image output by the DVD generation section 16 and takes the selected image as a second image shown in the diagram serving as FIG. 2 as a second image which is not subjected yet to the image combination process. The select section 17 outputs the selected first and second images to the two-image combination section 18. When the vehicle is put in a state of being stopped for example, the select section 17 typically selects the DVD-reproduced image output by the DVD generation section 16 and takes the selected image as the first and second images. When the vehicle is running, on the other hand, the select section 17 typically selects the navigation image output by the navigation section 15 as the first image and selects the DVD-reproduced image output by the DVD generation section 16 as the second image.

In a process of producing a combined image, the two-image combination section 18 combines the first and second images selected by the select section 17 by sorting out the first and second images in sub-pixel units to form a checker board design as shown in the diagram which serves as FIG. 2.

The EEPROM 19 is a memory used for storing electrical correction tables and optical correction tables for the R, G and B colors. The electrical correction table is a table of electrical correction data provided for all adjacent-sub-pixel gradations and for all gradations of sub-pixels which each serve as the subject of an electrical correction process. In the following description, a sub-pixel serving as the subject of an electrical correction process is also referred to as a correction-subject sub-pixel. An adjacent-sub-pixel gradation is the gradation of a sub-pixel adjacent to a correction-subject sub-pixel. On the other hand, the optical correction table is a table of optical correction data provided for all same-color sub-pixel gradations and for all gradations of sub-pixels which each serve as the subject of an optical correction process. The correction data is data found experimentally in advance.

The EEPROM controller 20 controls an operation to enter an input to the EEPROM 19 as well as an operation to generate an output from the EEPROM 19. The crosstalk correction section 21 carries out crosstalk correction by making use of a variety of LUTs (Lookup Tables) stored in the EEPROM 19. The output-signal generation section 22 controls the polarity and the timing of the corrected signal received from the crosstalk correction section 21 so that the corrected signal can be displayed on the liquid-crystal display section 23. The liquid-crystal display section 23 has a light shielding barrier 13, a liquid-crystal display panel 11 and other components such as a backlight, a gate driver and a source driver which are not shown in the diagram serving as FIG. 5. The liquid-crystal display panel 11 displays the combined image which is composed of first and second images. At that time, the liquid-crystal display panel 11 displays the first image in a visual-recognition direction and the second image in another visual-recognition direction in a state of being distinguishable from each other. That is to say, the liquid-crystal display section 23 displays R, G and B data received from the output-signal generation section 22 as the corrected signal on the liquid-crystal display panel 11 which is embedded in the liquid-crystal display section 23.

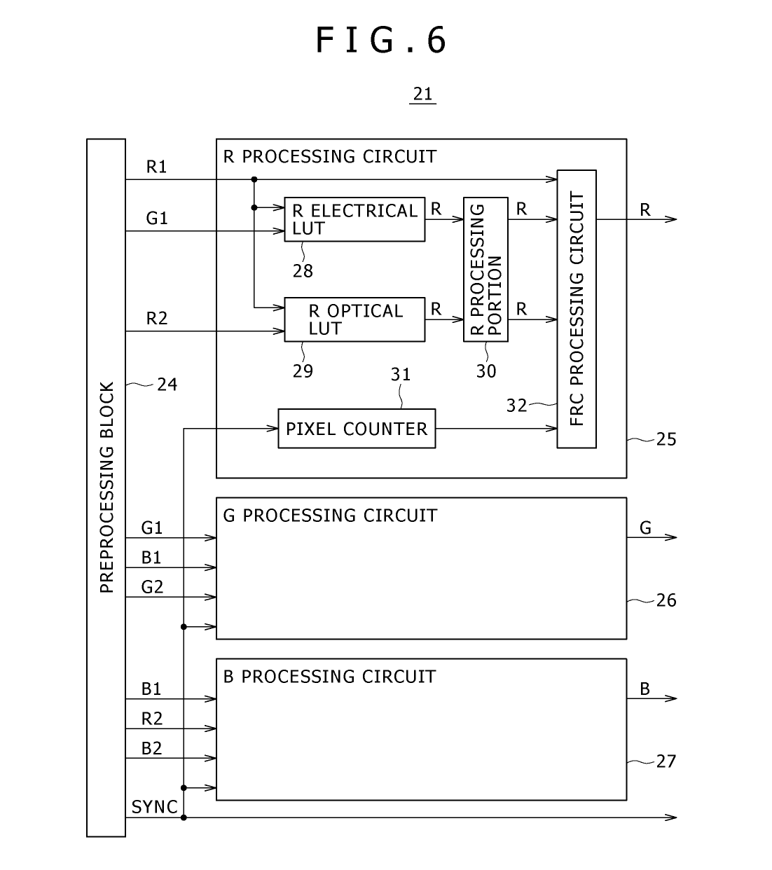

FIG. 6 is a block diagram showing details of main components composing the crosstalk correction section 21 employed in the two-image display apparatus 10 shown in the block diagram which serves as FIG. 5. As shown in the block diagram which serves as FIG. 6, the crosstalk correction section 21 employs a preprocessing block 24, an R processing circuit 25, a G processing circuit 26 and a B processing circuit 27. The preprocessing block 24 extracts necessary data from a combined image, which has been supplied by the two-image combination section 18, synchronously with a synchronization signal and supplies the necessary data to the R processing circuit 25, the G processing circuit 26 and the B processing circuit 27. The R processing circuit 25, the G processing circuit 26 and the B processing circuit 27 carry out crosstalk correction processing for the R, G and B colors respectively.

Let the number of bits composing gradation data of every sub-pixel in the two-image display apparatus 10 be 6. In this case, the luminance for the R, G and B colors has a value of one of 64 different gradations, i.e., gradation 0 to gradation 63. The two-image display apparatus 10 is assumed to be a normally black display apparatus in which gradation 0 is the luminance of the black color whereas gradation 63 is the luminance of the white color. The electrical LUT used as an electrical-crosstalk correction table is a table showing correction data found on the basis of gradations 0 to 63 of a correction-subject sub-pixel serving as the subject of a correction process and gradations 0 to 63 of an adjacent sub-pixel placed on a right-hand side adjacent to the correction-subject sub-pixel serving as the subject of a correction process. On the other hand, the optical LUT used as an optical-crosstalk correction table is a table showing correction data found on the basis of gradations 0 to 63 of a correction-subject sub-pixel serving as the subject of a correction process and gradations 0 to 63 of a same-color sub-pixel included in a pixel placed on a right-hand side adjacent to the correction-subject sub-pixel to serve as a same-color sub-pixel having the same color as the correction-subject sub-pixel.

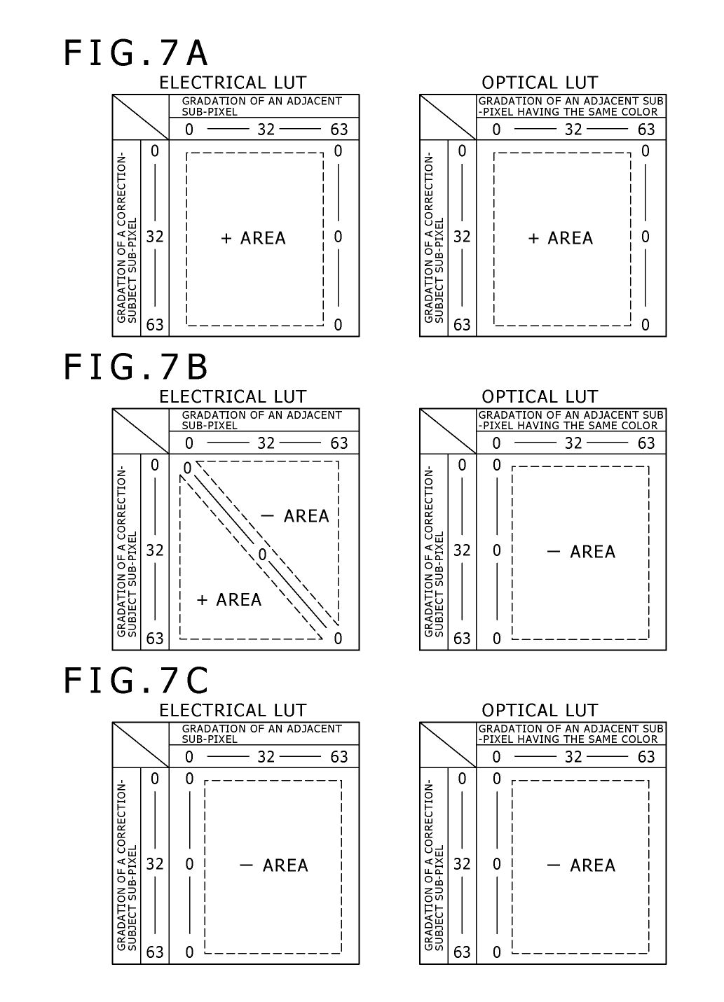

A gradation reference of an electrical LUT is a gradation assigned to the adjacent sub-pixel to serve as a gradation associated with correction data of 0. In the case of an electrical LUT shown on the left-hand side of a diagram which serves as FIG. 7A, the gradation reference is gradation 63 which is assigned to the white color and associated with correction data of 0. Thus, the electrical LUT shown on the left-hand side of the diagram serving as FIG. 7A is referred to as a white-reference electrical LUT.

In the case of an electrical LUT shown on the left-hand side of a diagram which serves as FIG. 7B, correction data of 0 used as the gradation reference represents a state in which the correction-subject sub-pixel serving as the subject of a correction process is not affected by an adjacent sub-pixel on the right-hand side adjacent to the correction-subject sub-pixel. That is to say, correction data of 0 used as the gradation reference is associated with the gradation of the correction-subject sub-pixel and the adjacent-sub-pixel gradation which is equal to the gradation of the correction-subject sub-pixel. Thus, the electrical LUT shown on the left-hand side of the diagram serving as FIG. 7B is referred to as an original-reference electrical LUT.

In the case of an electrical LUT shown on the left-hand side of a diagram which serves as FIG. 7C, on the other hand, the gradation reference is gradation 0 which is assigned to the black color and associated with correction data of 0. Thus, the electrical LUT shown on the left-hand side of the diagram serving as FIG. 7C is referred to as a black-reference electrical LUT.

That is to say, there are different kinds of electrical LUT and these different kinds of electrical LUT are distinguished from each other on the basis of which gradations are used as the gradation reference.

By the same token, a gradation reference of an optical LUT is a gradation assigned to a sub-pixel, which is included in the right-hand-side pixel adjacent to a correction-subject sub-pixel to function as a sub-pixel having the same color as the correction-subject sub-pixel, to serve as a gradation associated with correction data of 0. In the case of an optical LUT shown on the right-hand side of the diagram which serves as FIG. 7A, the gradation reference is gradation 63 which is assigned to the white color and associated with correction data of 0. Thus, the optical LUT shown on the right-hand side of the diagram serving as FIG. 7A is referred to as a white-reference optical LUT.

In the case of an optical LUT shown on the right-hand side of the diagram which serves as FIG. 7B, on the other hand, the gradation reference is gradation 0 which is assigned to the black color and associated with correction data of 0. In this case, the black color is a color for which the gradation of a sub-pixel included in the right-hand-side pixel adjacent to a correction-subject sub-pixel to serve as a sub-pixel having the same color as the correction-subject sub-pixel does not include an optical leak. Thus, the optical LUT shown on the right-hand side of the diagram serving as FIG. 7B is referred to as a black-reference optical LUT.

In the case of an optical LUT shown on the right-hand side of the diagram which serves as FIG. 7C, the gradation reference is also gradation 0 which is assigned to the black color and associated with correction data of 0. Thus, the optical LUT shown on the right-hand side of the diagram serving as FIG. 7C is the black-reference optical LUT cited above.

That is to say, there are different kinds of optical LUT and these different kinds f optical LUT are distinguished from each other on the basis of which gradations are used as the gradation reference.

In comparison with the original-reference electrical LUT, the white-reference electrical LUT has a merit that the white-reference electrical LUT can be used for carrying out an extensive correction process on the gradations of a portion having striking gradation differences and low luminance levels. On the other hand, the original-reference electrical LUT has a merit of sharp contrast.

As shown in the block diagram which serves as FIG. 6, the R processing circuit 25 employs an R electrical LUT 28, an R optical LUT 29, an R processing portion 30, a pixel counter 31 and an FRC processing circuit 32. The R electrical LUT 28 receives the gradation R1 of the correction-subject sub-pixel and the gradation G1 of the adjacent sub-pixel on the right-hand side of the correction-subject sub-pixel from the preprocessing block 24. Then, on the basis of the gradation R1 of the correction-subject sub-pixel and the gradation G1 of the adjacent sub-pixel, the R electrical LUT 28 selects electrical correction data from the electrical correction table (LUT) transferred from the EEPROM 19 to the crosstalk correction section 21 and, then, extracts the selected electrical correction data, outputting the extracted electrical correction data to the R processing portion 30.

By the same token, the R optical LUT 29 receives the gradation R1 of the correction-subject sub-pixel and the gradation R2 of a same-color sub-pixel included in the right-hand-side pixel adjacent to the correction-subject sub-pixel to serve as a same-color sub-pixel having the same color (R) as the correction-subject sub-pixel from the preprocessing block 24. Then, on the basis of the gradation R1 of the correction-subject sub-pixel and the gradation R2 of the same-color sub-pixel having the same color (R) as the correction-subject sub-pixel, the R optical LUT 29 selects optical correction data from the optical correction table (LUT) transferred from the EEPROM 19 to the crosstalk correction section 21 and, then, extracts the selected optical correction data, outputting the extracted optical correction data to the R processing portion 30.

The R processing portion 30 adds the electrical correction data received from the R electrical LUT 28 to the optical correction data received from the R optical LUT 29 in order to produce a sum which is output to the FRC processing circuit 32.

Synchronously with a sync signal received from the preprocessing block 24, the pixel counter 31 counts the number of processed pixels. As described above, the FRC processing circuit 32 adds a sum received from the R processing portion 30 as the sum the electrical correction data received from the R electrical LUT 28 and the optical correction data received from the R optical LUT 29 to a gradation received from the preprocessing block 24 as the gradation R1 of the correction-subject sub-pixel. In addition, on the basis of a count output by the pixel counter 31 to serve as the number of processed pixels, the FRC processing circuit 32 also carries out an FRC (Frame Rate Control) process taking four frames as one period on the sum received from the R processing portion 30 to serve as R data and outputs resulting R data to the output-signal generation section 22.

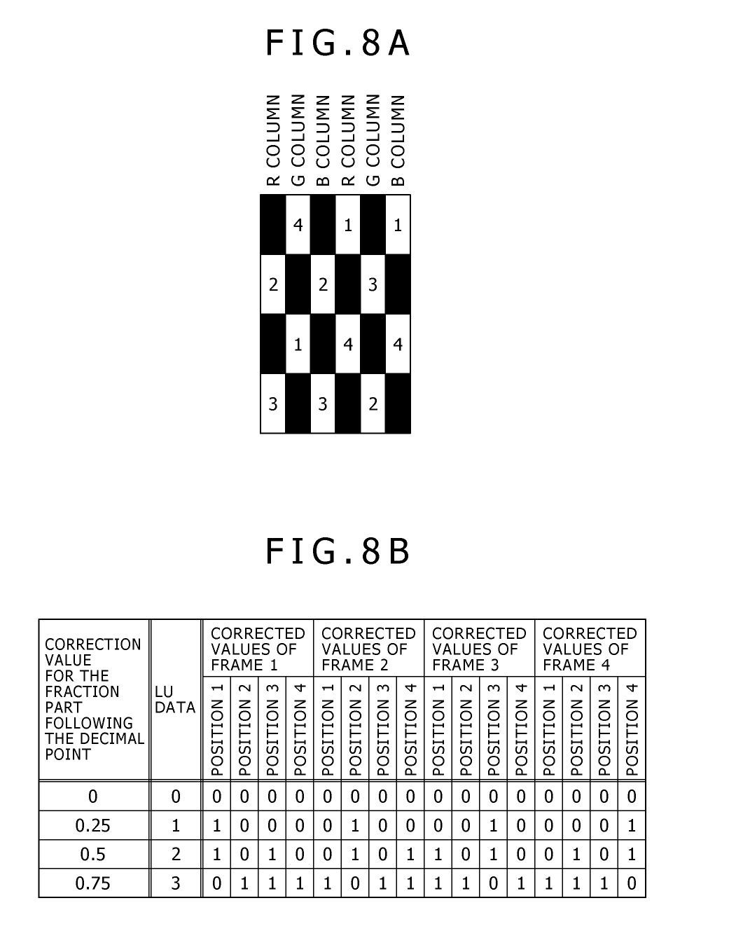

FIG. 8A is a diagram showing a typical sub-pixel layout of the FRC process which handles four frames as one period whereas FIG. 8B is a table showing correction values for the four frames. The control to drive the luminance of the liquid-crystal display panel 11 is carried out in gradation units. That is to say, a non-integer gradation cannot be specified. However, the period of one screen (consisting of 800 pixels×480 pixels) is short, that is, the frame frequency of 60 Hz is high. Thus, by making use of a residual image, as shown by the table of FIG. 8B, with four frames taken as one period, the FRC process appears to be carried out in 0.25-gradation units as a process in which the number of frames increasing by 1 gradation in one period is one. For example, in a period of 1.75 gradations, among four frames of one period, one frame is taken as 1 gradation and the three remaining frames are taken as 2 gradations so that the residual image makes it possible to see the period as 1.75 gradations.

In addition, in order to reduce the number of flickers, as shown in the diagram serving as FIG. 8A, the position of a sub-pixel giving an increase of 1 gradation is scattered by changing the position of the frame.

The configuration of the G processing circuit 26 and the configuration of the B processing circuit 27 are each identical with the configuration of the R processing circuit 25. That is to say, the G processing circuit 26 makes use of an electrical LUT and an optical LUT for sub-areas in order to carry out a crosstalk correction process on G data received from the preprocessing block 24, outputting the result of the crosstalk correction process to the output-signal generation section 22. By the same token, the B processing circuit 27 makes use of an electrical LUT and an optical LUT for sub-areas in order to carry out a crosstalk correction process on B data received from the preprocessing block 24, outputting the result of the crosstalk correction process to the output-signal generation section 22. Since the FRC process is carried out as described above, a fine display can of course be produced and, in addition, there is given an effect that a boundary line between the sub-areas becomes hardly visible.

Next, image processing carried out by the two-image display apparatus 10 having the configuration described above is explained as follows. The two-image display apparatus 10 is provided with a power-supply switch which is shown in none of the figures. When the power-supply switch of the two-image display apparatus 10 is put in a turned-on state, the EEPROM controller 20 transfers electrical and optical correction tables for the R, G and B colors from the EEPROM 19 to the crosstalk correction section 21. The select section 17 selects the navigation image output by the navigation section 15 or the DVD-reproduced image output by the DVD generation section 16 and takes the selected image as a first image which is shown in the diagram serving as FIG. 2 as a first image not subjected yet to the image combination process. In addition, the select section 17 also selects the navigation image output by the navigation section 15 or the DVD-reproduced image output by the DVD generation section 16 and takes the selected image as a second image which is shown in the diagram serving as FIG. 2 as a second image not subjected yet to the image combination process. The select section 17 outputs the selected first and second images to the two-image combination section 18.

The two-image combination section 18 combines the first and second images selected by the select section 17 by sorting out the first and second images in sub-pixel units to form a checker board design as shown in the diagram serving as FIG. 2 in order to generate a combined image. Typically, the first and second images as well as the combined image are each an image which is composed of 800 pixels×480 pixels.

The preprocessing block 24 employed in the crosstalk correction section 21 extracts necessary data from a combined image, which has been supplied by the two-image combination section 18, synchronously with a synchronization signal and supplies the necessary data to the R processing circuit 25, the G processing circuit 26 and the B processing circuit 27. The R processing circuit 25, the G processing circuit 26 and the B processing circuit 27 carry out crosstalk correction processing for the R, G and B colors respectively.

In the R processing circuit 25, the R electrical LUT 28 receives the gradation R1 of the correction-subject sub-pixel and the gradation G1 of the adjacent sub-pixel on the right-hand side of the correction-subject sub-pixel from the preprocessing block 24. Then, on the basis of the gradation R1 of the correction-subject sub-pixel and the gradation G1 of the adjacent sub-pixel, the R electrical LUT 28 selects electrical correction data from the electrical correction table (LUT) transferred from the EEPROM 19 to the crosstalk correction section 21 and, then, extracts the selected electrical correction data, outputting the extracted electrical correction data to the R processing portion 30.

By the same token, the R optical LUT 29 receives the gradation R1 of the correction-subject sub-pixel and the gradation R2 of a same-color sub-pixel included in the right-hand-side pixel adjacent to the correction-subject sub-pixel to serve as a sub-pixel having the same color (R) as the correction-subject sub-pixel from the preprocessing block 24. Then, on the basis of the gradation R1 of the correction-subject sub-pixel and the gradation R2 of the same-color sub-pixel having the same color (R) as the correction-subject sub-pixel, the R optical LUT 29 selects optical correction data from the optical correction table (LUT) transferred from the EEPROM 19 to the crosstalk correction section 21 and, then, extracts the selected optical correction data, outputting the extracted optical correction data to the R processing portion 30.

The R processing portion 30 adds the electrical correction data received from the R electrical LUT 28 to the optical correction data received from the R optical LUT 29 in order to produce a sum which is output to the FRC processing circuit 32. As will be described below, the FRC processing circuit 32 adds the sum to a gradation received from the preprocessing block 24 as the gradation R1 of the correction-subject sub-pixel.

Synchronously with a sync signal received from the preprocessing block 24, the pixel counter 31 counts the number of processed pixels. As described above, the FRC processing circuit 32 adds a sum received from the R processing portion 30 as the sum the electrical correction data received from the R electrical LUT 28 and the optical correction data received from the R optical LUT 29 to a gradation received from the preprocessing block 24 as the gradation R1 of the correction-subject sub-pixel. In addition, on the basis of a count output by the pixel counter 31 to represent the number of processed pixels, the FRC processing circuit 32 also carries out an FRC (Frame Rate Control) process taking four frames as one period on the sum received from the R processing portion 30 to serve as R data and outputs resulting R data to the output-signal generation section 22.

The configuration of the G processing circuit 26 and the configuration of the B processing circuit 27 are each identical with the configuration of the R processing circuit 25. That is to say, the G processing circuit 26 makes use of an electrical LUT and an optical LUT for sub-areas in order to carry out a crosstalk correction process on G data received from the preprocessing block 24, outputting the result of the crosstalk correction process to the output-signal generation section 22. By the same token, the B processing circuit 27 makes use of an electrical LUT and an optical LUT for sub-areas in order to carry out a crosstalk correction process on B data received from the preprocessing block 24, outputting the result of the crosstalk correction process to the output-signal generation section 22. The output-signal generation section 22 controls the polarity (and the timing) of the corrected signal received from the crosstalk correction section 21 as the results of the crosstalk correction process so that the corrected signal can be displayed on the liquid-crystal display section 23 and provides the liquid-crystal display section 23 with the corrected signal having its polarity and timing controlled. The liquid-crystal display section 23 displays R, G and B data received from the output-signal generation section 22 as the corrected signal having its polarity and timing controlled on the liquid-crystal display panel 11 which is embedded in the liquid-crystal display section 23.

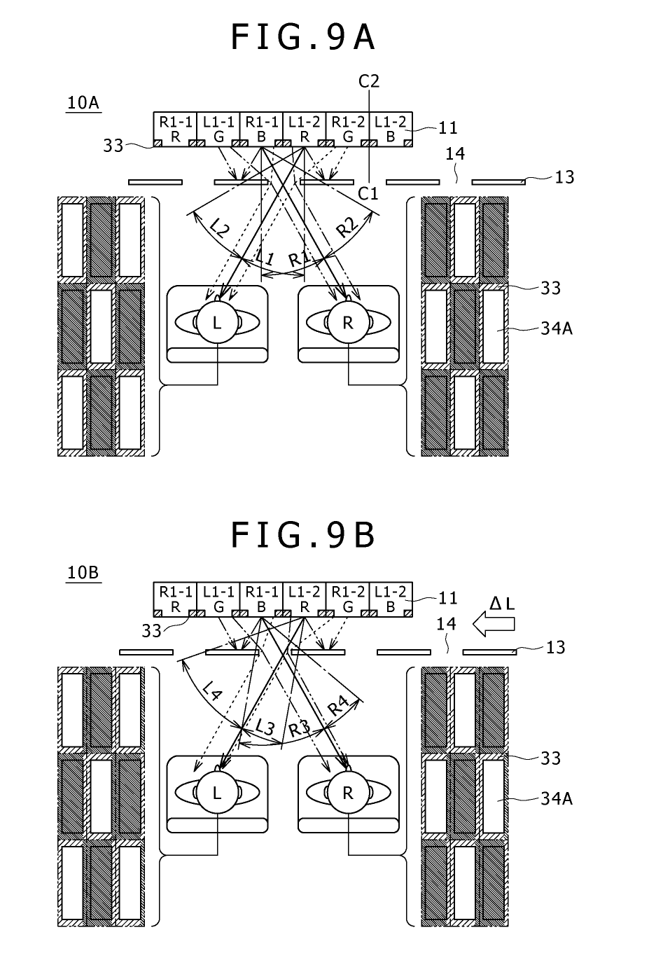

Next, the following description explains differences between a two-image display apparatus 10A given as a first typical comparison configuration shown in a diagram serving as FIG. 9A and a two-image display apparatus 10B given as a second typical comparison configuration shown in a diagram serving as FIG. 9B. As shown in the diagram serving as FIG. 9A, in the two-image display apparatus 10A, slit-shaped apertures 14 of the light shielding barrier 13 are not shifted. As shown in the diagram serving as FIG. 9B, in the two-image display apparatus 10B, on the other hand, slit-shaped apertures 14 of the light shielding barrier 13 are shifted in a horizontal direction toward the side of the assistant-driver seat L.

As shown in the diagram serving as FIG. 9A, in a display area 12 of the two-image display apparatus 10A in which the slit-shaped apertures 14 of the light shielding barrier 13 are not shifted, BMs (black matrixes) 33 each made from a light shielding material are created in the row and column directions at locations corresponding to the positions of signal and scan lines not shown in the diagram serving as FIG. 9A. An area enclosed in a BM 33 is an image area 34A for displaying an image. The image area 34A of the two-image display apparatus 10A in which the slit-shaped apertures 14 of the light shielding barrier 13 are not shifted is created with a uniform size which is symmetrical in the horizontal direction.

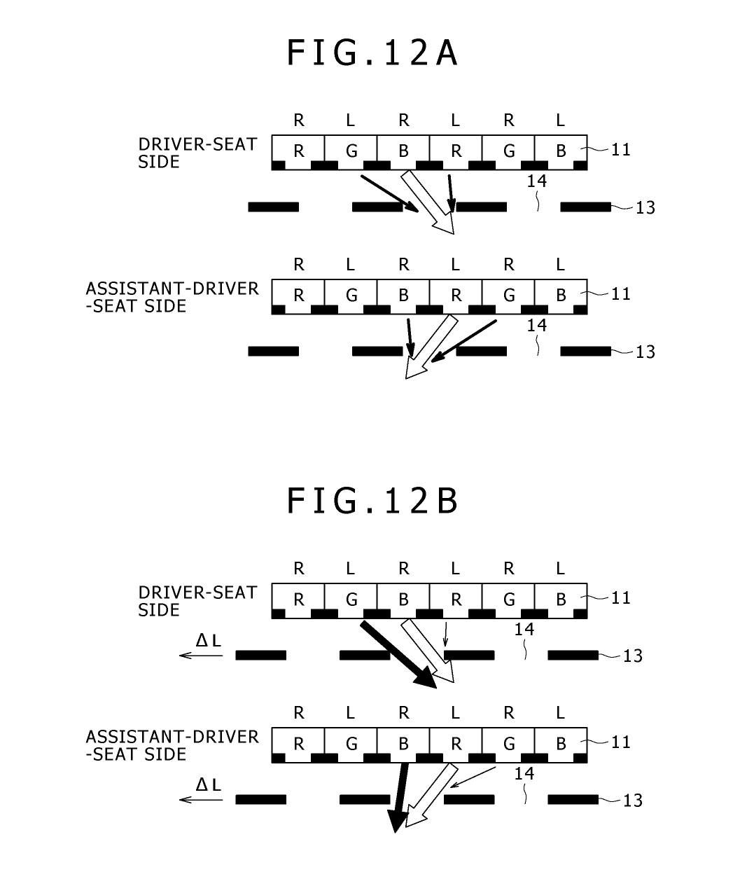

In the two-image display apparatus 10A in which the slit-shaped apertures 14 of the light shielding barrier 13 are not shifted, the center C1 of the slit-shaped aperture 14 coincides with the center C2 of the BM 33 between two image areas 34A adjacent to each other. Let reference symbol R1 denote an inner-side field included in a visual-field range seen from the driver seat R to serve as an inner-side field with respect to a visual recognition direction to the driver seat R. On the other hand, let reference symbol R2 denote an outer-side field included in the visual-field range seen from the driver seat R to serve as an outer-side field with respect to the visual recognition direction to the driver seat R. By the same token, let reference symbol L1 denote an inner-side field included in a visual-field range seen from the assistant-driver seat L to serve as an inner-side field with respect to a visual recognition direction to the assistant-driver seat L. On the other hand, let reference symbol L2 denote an outer-side field included in the visual-field range seen from the assistant-driver seat L to serve as an outer-side field with respect to the visual recognition direction to the assistant-driver seat L. In this case, equations R1=L1 and R2=L2 hold true. That is to say, the visual-field range seen from the driver seat R and the visual-field range seen from the assistant-driver seat L are shifted symmetrically from each other. In addition, equations R1=R2 and L1=L2 also hold true as well. That is to say, the visual-field range seen from the driver seat R is symmetrical with respect to the visual recognition direction to the driver seat R whereas the visual-field range seen from the assistant-driver seat L is symmetrical with respect to the visual recognition direction to the assistant-driver seat L. In this case, the image area 34A is designed to have such an approximately rectangular shape that the image area 34A becomes symmetrical in the horizontal direction. As shown in the upper and lower diagrams which serve as FIG. 12A explained before, the quantity of transmitted light in an area on the left-hand side of the image area 34A is equal to the quantity of transmitted light in an area on the right-hand side of the image area 34A. The left-hand side of the image area 34A is the side of the assistant-driver seat L or the side of the second visual recognition direction whereas the right-hand side of the image area 34A is the side of the driver seat R or the side of the first visual recognition direction.

In the two-image display apparatus 10B in which the slit-shaped apertures 14 of the light shielding barrier 13 are shifted in a horizontal direction toward the side of the assistant-driver seat L, on the other hand, for the sake of traffic safety, the driver is deliberately made incapable of peeping the second image displayed on the side of the assistant-driver seat L. In order to make the driver incapable of peeping the second image displayed on the side of the assistant-driver seat L, the slit-shaped aperture 14 are shifted from their respective positions shown in the diagram serving as FIG. 9A in a horizontal direction toward the side of the assistant-driver seat L by a distance ΔL as shown in the diagram serving as FIG. 9B. Thus, relations R3>R4 and L4>L3 hold true. In addition, relations (R1+R2)≈(R3+R4) and (L1+L2)≈(L3+L4) also hold true as well. In these relations, reference symbol R3 denotes an inner-side field included in the visual-field range seen from the driver seat R to serve as an inner-side field with respect to the visual recognition direction to the driver seat R. On the other hand, reference symbol R4 denotes an outer-side field included in the visual-field range seen from the driver seat R to serve as an outer-side field with respect to the visual recognition direction to the driver seat R. By the same token, reference symbol L3 denotes an inner-side field included in the visual-field range seen from the assistant-driver seat L to serve as an inner-side field with respect to the visual recognition direction to the assistant-driver seat L. On the other hand, reference symbol L4 denotes an outer-side field included in the visual-field range seen from the assistant-driver seat L to serve as an outer-side field with respect to the visual recognition direction to the assistant-driver seat L.

That is to say, without regard to whether or not the slit-shaped apertures 14 of the light shielding barrier 13 are shifted, both the visual-field range on the side of the driver seat R and the visual-field range on the side of the assistant-driver seat L do not change that much unless the slit-shaped apertures 14 of the light shielding barrier 13 are shifted by a long distance. Rather, with the slit-shaped apertures 14 of the light shielding barrier 13 shifted, the visual-field range on the side of the driver seat R is shifted in a direction to the side of the assistant-driver seat L but, conversely, the visual-field range on the side of the assistant-driver seat L is shifted in a direction departing from the side of the driver seat R.

As is obvious from the description given above, in comparison with the two-image display apparatus 10A given as a first typical comparison configuration shown in the diagram serving as FIG. 9A, the two-image display apparatus 10B given as a second typical comparison configuration shown in the diagram serving as FIG. 9B makes it difficult for the driver to visually recognize an image displayed on the side of the assistant-driver seat L so that the traffic safety is enhanced. That is to say, even if the driver moves its head a little bit to the side of the assistant-driver seat L, the driver is still not capable of visually recognizing the image displayed on the side of the assistant-driver seat L so that the traffic safety is enhanced.

If the image area 34B in the two-image display apparatus 10B given as a second typical comparison configuration is made horizontally symmetrical as is the case with the image area 34A in the two-image display apparatus 10A given as a first typical comparison configuration shown in the diagram serving as FIG. 9A, however, in both the visual recognition direction from the driver seat R and the visual recognition direction from the assistant-driver seat L, the visual-field range is leaned more to the side of the assistant-driver seat L than to the side of the driver seat R. Thus, as shown in the upper and lower diagrams serving as FIG. 12B, an optical leak coming from an adjacent sub-pixel on the side to which the visual-field range is leaned increases. That is to say, the optical leak coming from an adjacent sub-pixel on the left-hand side increases. Conversely, an optical leak coming from an adjacent sub-pixel on a side opposite to the side toward which the visual-field range is leaned decreases. That is to say, the optical leak coming from an adjacent sub-pixel on the right-hand side decreases. As a result, the magnitude of the optical leak coming from an adjacent sub-pixel on the left-hand side is different from the magnitude of the optical leak coming from an adjacent sub-pixel on the right-hand side. If the magnitude of the optical leak coming from an adjacent sub-pixel on the left-hand side is different from the magnitude of the optical leak coming from an adjacent sub-pixel on the right-hand side, the two-image display apparatus demands two optical LUTs each used for storing correction data used correcting optical crosstalk. One of the two optical LUTs is demanded for the side of the driver seat R whereas the other optical LUT is demanded for the side of the assistant-driver seat L. Thus, much labor is demanded in the development of the two-image display apparatus. In addition, the storage capacity of a memory used for storing the two optical LUTs must be increased, undesirably giving rise to a high cost.

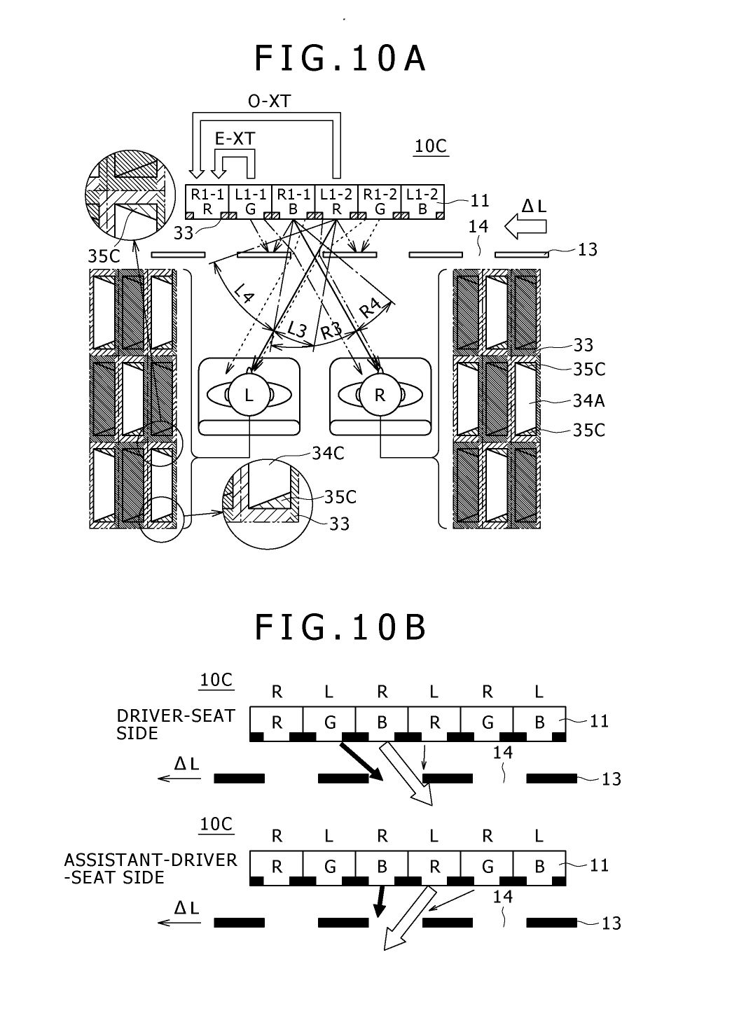

In order to solve the problems described above, there is provided a two-image display apparatus 10C shown in a diagram serving as FIG. 10A to function as a two-image display apparatus 10C according to the embodiment. As shown in this figure, every image area 34C on the liquid-crystal display panel 11 is created to have a trapezoidal shape when viewed from a position above the image area 34C as follows. The image area 34C is provided with two correction light shielding sections 35C which are each a light shielding member having a shape resembling a wedge. The image area 34C is provided with the two correction light shielding sections 35C in such a way that the trapezoidal shape has a long side on the side of the assistant-driver seat L and a short side on the side of the driver seat R. As described earlier, the side of the assistant-driver seat L is a side, in a direction toward which the slit-shaped aperture 14 is shifted. In the case of the embodiment, the side of the assistant-driver seat L is the left-hand side of the sub-pixel. On the other hand, the side of the driver seat R is a side which the slit-shaped aperture 14 is shifted away from in a direction opposite to the direction toward the side of the assistant-driver seat L. In the case of the embodiment, the side of the driver seat R is the right-hand side of the sub-pixel. The correction light shielding section 35C can be created by extending the BM 33. As an alternative, the correction light shielding section 35C may also be created in the same process as the signal line and the scan line from the same material as the signal line and the scan line. It is to be noted that the signal line and the scan line are not shown in the diagram which serves as FIG. 10A. In addition, the correction light shielding section 35C may also be created in a separate process which is additionally provided specially for the correction light shielding section 35C.

Thus, in the image area 34C of every sub-pixel, the correction light shielding section 35C reduces the quantity of transmitted light in an area in a direction opposite to the direction in which the slit-shaped aperture 14 is shifted to a value smaller than the quantity of transmitted light in an area in the direction in which the slit-shaped aperture 14 is shifted. As is obvious from the above descriptions, the area in a direction opposite to the direction in which the slit-shaped aperture 14 is shifted is an area on the right-hand side of the sub-pixel. On the other hand, the area in the direction in which the slit-shaped aperture 14 is shifted is an area on the left-hand side of the sub-pixel.

The upper diagram of FIG. 10B shows the state of optical leaks for the side of the driver seat R. A sub-pixel G is a sub-pixel for the side of the assistant driver seat L whereas a sub-pixel B is a sub-pixel for the side of the driver seat R. The sub-pixel G is a sub-pixel adjacent to the sub-pixel B and located on the left-hand side of the sub-pixel B. If such a liquid-crystal display panel 11 is used and the light shielding barrier 13 is shifted in a direction toward the side of the assistant-driver seat L by a distance ΔL as described above, the quantity of light transmitted by the sub-pixel G to an area on the right-hand side is reduced due to the effect of the correction light shielding section 35C.

Thus, unlike the optical leak shown in the upper diagram of FIG. 12B for the side of the driver seat, the magnitude of the optical leak coming from the adjacent sub-pixel G is reduced so that the effect of the optical leak coming from the adjacent sub-pixel G on the sub-pixel B can be certainly decreased. As a result, it is possible to produce an approximately blue display of the sub-pixel B with a substantially reduced effect of the green color (G) on the blue color (B).

On the other hand, the lower diagram of FIG. 10B shows the state of an optical leak for the side of the assistant-driver seat L. A sub-pixel R is a sub-pixel for the side of the assistant driver seat L whereas a sub-pixel B is a sub-pixel for the side of the driver seat R. The sub-pixel B is sub-pixel adjacent to the sub-pixel R and located on the left-hand side of the sub-pixel R. If such a liquid-crystal display panel 11 is used and the light shielding barrier 13 is shifted in a direction toward the side of the assistant-driver seat L by a distance ΔL as described above, the quantity of light transmitted by the sub-pixel R to an area on the left-hand side is reduced due to the effect of the correction light shielding section 35C.

Thus, unlike the optical leak shown in the lower diagram of FIG. 12B for the side of the assistant-driver seat, the magnitude of the optical leak coming from the adjacent sub-pixel B is reduced so that the effect of the optical leak coming from the adjacent sub-pixel B on the sub-pixel R can be certainly decreased. As a result, it is possible to produce an approximately red display of the sub-pixel R with a substantially reduced effect of the blue color (B) on the red color (R).

As described above, much like a configuration in which the light shielding barrier is not shifted, it is possible to establish a balance between the optical leak seen from the side of the driver seat as an optical leak coming from a sub-pixel adjacent to a sub-pixel for the side of the driver seat and the optical leak seen from the side of the assistant-driver seat as an optical leak coming from a sub-pixel adjacent to a sub-pixel for the side of the assistant-driver seat.

Thus, only one optical correction LUT is demanded to serve as an LUT for storing correction data to be used in correction of optical crosstalk. That is to say, the two-image display apparatus does not demand two optical LUTs each used for storing correction data used correcting optical crosstalk. In this case, one of the two optical LUTs is demanded for the side of the driver seat R whereas the other optical LUT is required for the side of the assistant-driver seat L. If the two-image display apparatus demands the two optical LUTs, the storage capacity of a memory used for storing the two optical LUTs needs to be increased, undesirably giving rise to a high cost. In addition, the size of the correction light shielding section 35C can be increased gradually in a direction from the side of the assistant-driver seat L to the side of the driver seat R. Thus, there is provided a merit that the luminance does not change much even if the visual-recognition direction is shifted a little bit from the design position.

It is to be noted that, with regard to the horizontal adjustment of the image area 34C, it is desirable to properly set the dimensions of the trapezoidal shape of the image area 34C. In addition, it is also desirable to set correction light shielding sections 35C in each image area 34C in order to make the magnitudes of optical leaks coming from adjacent sub-pixels equal to each other.

Modified Versions

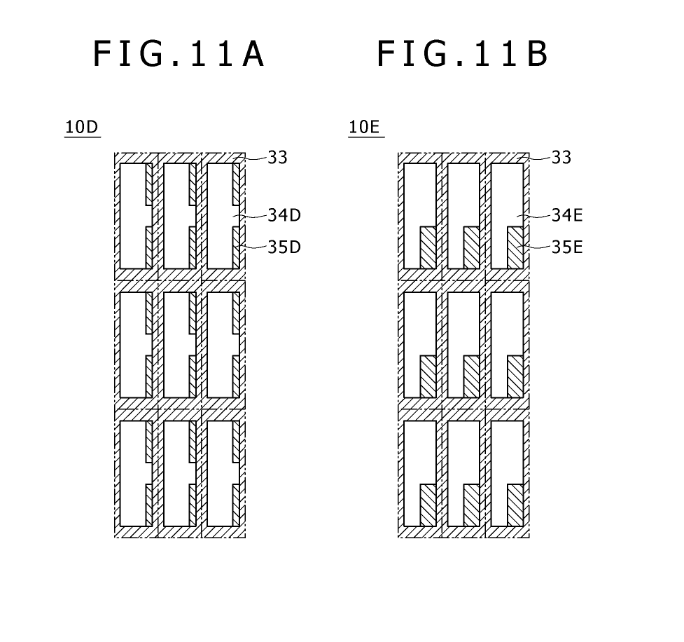

In the two-image display apparatus 10C according to the embodiment, the image area 34C is created to have a trapezoidal shape in order to reduce optical leaks generated on the side of the driver seat R. Even if the image area has a shape other than the trapezoidal shape, however, it is also possible to obtain the same effect as that of the image area 34C which is created to have the trapezoidal shape. In the case of a two-image display apparatus 10D provided as a first modified version shown in a diagram serving as FIG. 11A for example, two rectangular correction light shielding sections 35D are provided at respectively upper and lower corners on the right-hand side of every sub-pixel in order to narrow the right-hand side portion of the image area 34D.

As an alternative, in the case of a two-image display apparatus 10E provided as a second modified version shown in a diagram serving as FIG. 11B, on the other hand, one rectangular correction light shielding section 35E is provided at the lower corner on the right-hand side of every sub-pixel in order to narrow the right-hand side portion of the image area 34E.

It is to be noted that each of the correction light shielding sections 35C to 35E may be provided with a TFT (Thin Film Transistor) used as a switching device and a light shielding substance such as a photo spacer for sustaining the thickness of the liquid crystal.

The embodiment described above implements a two-image display apparatus which employs a liquid-crystal display panel. It is also worth noting, however, that the present embodiment can also be applied to display panels other than the liquid-crystal display panel. Typical display panels other than the liquid-crystal display panel include an organic EL display panel. In addition, the present embodiment can also be applied to a display apparatus in which every pixel has one sub-pixel. The display apparatus in which every pixel has one sub-pixel is referred to as a monochrome display apparatus or a mono-color display apparatus. On top of that, the present embodiment can also be applied to a two-image display apparatus mounted in a car with the steering wheel provided on the left-hand side. In addition, the present embodiment can also be applied to a two-image display apparatus including a display panel sandwiched by a group of students and a teacher who face each other as disclosed in Patent Document 2 described earlier.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A two-image display apparatus comprising:
a display panel in which each sub-pixel for displaying a first image and each sub-pixel for displaying a second image are placed alternately at positions adjacent to each other; and
a light shielding barrier having apertures for allowing said first and second images displayed in a first visual recognition direction and a second visual recognition direction respectively to be distinguished from each other, wherein
the center of each of said apertures is shifted from the center between two-image areas allocated to two said adjacent sub-pixels respectively toward the side of said second visual recognition direction, and
there is also provided a correction light shielding section configured to narrow an image area allocated on the side of said first visual recognition direction to serve as said image area provided for one of said adjacent sub-pixels.

2. The two-image display apparatus according to claim 1 wherein
said correction light shielding section has a shape which is gradually widened in a direction from said second visual recognition direction to said first visual recognition direction.

3. The two-image display apparatus according to claim 1 wherein
said correction light shielding section has a shape for partially shielding light propagating in the direction of a column, along which said sub-pixels are laid out, on the side of said first visual recognition direction.

4. The two-image display apparatus according to claim 1 wherein
said correction light shielding section is created so that the magnitude of an optical leak generated on the side of said first visual recognition direction is equal to said magnitude of an optical leak generated on the side of said second visual recognition direction.
